(19) United States
(12) Patent Application Publication
(10) Pub. No.: US 2009/0167875 A1
(43) Pub. Date: Jul. 2, 2009

(54) SYSTEM AND METHOD FOR IMAGE CAPTURING WITH AN AUDIBLE COUNTDOWN

(75) Inventor: SHUN-HSING HO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/131,041

(22) Filed: May 31, 2008

(30) Foreign Application Priority Data
Dec. 28, 2007 (CN) 200710203542.9

(51) Int. Cl. H04N 5/232; G08B 1/00

(52) U.S. Cl. 348/207.99; 340/309.7; 340/384.1; 348/E05.042

(57) ABSTRACT

A method for image capturing with an audible countdown includes: providing a handheld device (1), which comprises an image capture button (12), a speaker (13), a camera (14) and a memory (15) that stores multiple audible countdown signals; pressing the image capture button; selecting an audible countdown signal from the memory; playing the selected audible countdown signal through the speaker; and capturing an image through the camera after the selected audible countdown signal is finished playing.

### BACKGROUND OF THE INVENTION

1. Field of the Invention

The present invention generally relates to image capturing, and particularly to a system and method for capturing an image with an audible countdown.

2. Description of Related Art

Generally, a handheld device is a pocket-sized computing device, which typically includes a small visual display for output and a miniature keyboard or touch screen for input. Specifically, the handheld device may be a mobile phone, a personal digital assistant (PDA), a handheld game player, a digital camera, or a palm computer, etc.

When using a camera to capture a self image, a user needs to position the camera, press an image capture button, position himself in front of the camera lens, and wait for a time delay to elapse. However, the above-described preparations for capturing the self image have some disadvantages. For example, there may be no warning for when the delay is over, or just a visual cue provided, which may be difficult for the user to see, particularly if the user is facing the sun or some other bright light source.

Accordingly, what is needed is a system and method for image capturing with an audible countdown.

### SUMMARY

One exemplary embodiment provides a system for image capturing with an audible countdown. The system is installed in a handheld device, which includes an image capture button, a speaker, a camera, and a memory that stores multiple audible countdown signals. The system includes a selecting module, a playing module, and a capturing module. The selecting module is configured for selecting an audible countdown signal from the memory when the image capture button is pressed. The playing module is configured for playing the selected audible countdown signal through the speaker. The capturing module is configured for capturing the image through the camera after the selected audible countdown signal is finished playing.

Other systems, methods, features, and advantages will be or become apparent to one skilled in the art upon examination of the following drawings and detailed description.

### BRIEF DESCRIPTION OF THE DRAWINGS

FIG. 1 is a block diagram of a system for image capturing with an audible countdown in accordance with an exemplary embodiment of the present invention.

FIG. 2 is a flowchart of a method for image capturing with an audible countdown in accordance with the exemplary embodiment.

### DETAILED DESCRIPTION OF THE EMBODIMENTS

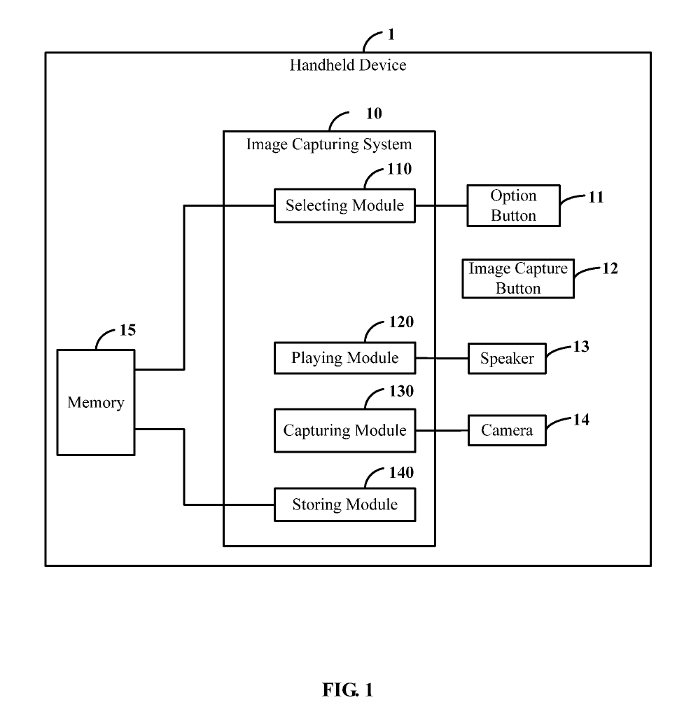

FIG. 1 is a block diagram of a system for image capturing with an audible countdown (hereinafter, “the image capturing system”) in accordance with an exemplary embodiment of the present invention. The image capturing system 10, which is installed and run in a handheld device 1, includes an option button 11, an image capture button 12, a speaker 13, a camera 14, and a memory 15.

The handheld device 1 may be a mobile phone, a personal digital assistant (PDA), a handheld game player, a digital camera, a palm computer, or other portable electronic devices.

The memory 15 may be an internal memory or an external memory card. The external memory card may be a smart media card (SMC), a secure digital card (SDC), a compact flash card (CFC), a multi media card (MMC), a memory stick (MS), an extreme digital card (XDC), a trans flash card (TFC) etc. The memory is configured for prestoring multiple audible countdown signals, and for storing captured images.

The image capturing system 10 includes a selecting module 110, a playing module 120, a capturing module 130, and a storing module 140.

The selecting module 110 is connected to the option button 11, and configured for providing a user interface that includes a plurality of delay times corresponding to the multiple audible countdown signals respectively, and guiding a user to select a delay time from the user interface through the option button 11. For example, the selecting module 110 may provide several delay times, such as “no delay”, “delay 5 seconds”, and “delay 10 seconds”. The user may select a delay time from the provided delay times according to actual demands and personal preference.

The selecting module 110 is also connected to the memory 15, and configured for selecting an audible countdown signal if other than “no delay” is selected and for selecting a delay time from the memory 15, when the image capture button 12 is pressed. For example, if the user selects “delay 5 seconds”, the selecting module 110 selects the corresponding audible countdown signal which may be a human or an electronic voice saying, “5, 4, 3, 2, 1”; or if the user selects “delay 10 seconds”, the selecting module 110 selects the corresponding audible countdown signal which may be a human or artificial voice saying, “10, 9, 8, 7, 6, 5, 4, 3, 2, 1”.

The playing module 120 is connected to the speaker 13, and configured for playing the selected audible countdown signal through the speaker 13.

The capturing module 130 is connected to the camera 14, and configured for capturing an image through the camera 14 after the selected audible countdown signal is finished playing.

The storing module 140 is connected to the memory 15, and configured for storing the captured image into the memory 15.

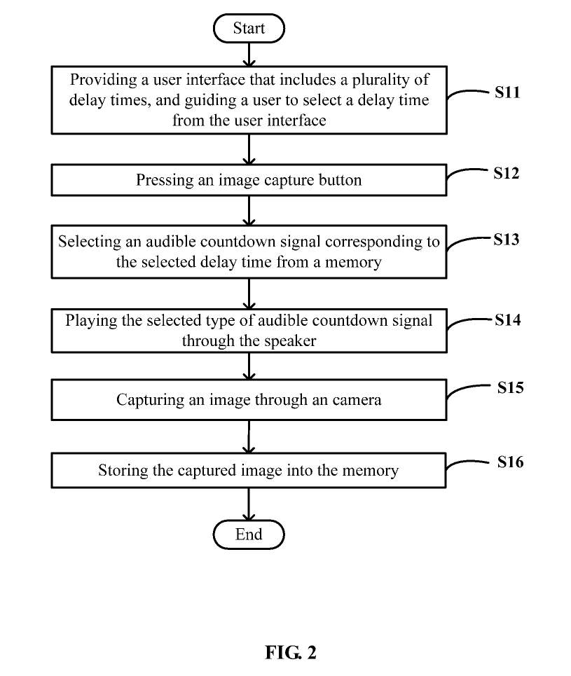

FIG. 2 is a flowchart of a method for image capturing with an audible countdown in accordance with the exemplary embodiment.

In step S11, the selecting module 110 provides the user interface that includes a plurality of delay times corresponding to the multiple audible countdown signals respectively, and guides the user to select a delay time from the user interface through the option button 11.

In step S12, the image capture button 12 is pressed by the user to capture an image.

In step S13, the selecting module 110 selects the audible countdown signal if other than “no delay” is selected and selects the corresponding delay time from the memory 15 when the image capture button 12 is pressed.

In step S14, the playing module 120 plays the selected audible countdown signal through the speaker 13. After the selected audible countdown signal finishes playing then go to step S15.

In step S15, the capturing module 130 captures an image through the camera 14.

In step S16, the storing module 140 stores the captured image into the memory 15, and the procedure ends.

It should be emphasized that the above-described embodiments of the exemplary embodiments, particularly, any “exemplary” embodiments, are merely possible examples of implementations, merely set forth for a clear understanding of the principles of the invention. Many variations and modifications may be made to the above-described exemplary embodiment(s) without departing substantially from the spirit and principles of the invention. All such modifications and variations are intended to be included herein within the scope of this disclosure and the above-described exemplary embodiment(s) and protected by the following claims.

What is claimed is:

1. A system for image capturing with an audible countdown, the system being part of a handheld device, the handheld device comprises an image capture button, a speaker, a camera and a memory that stores multiple audible countdown signals, the system comprising:
a selecting module configured for selecting an audible countdown signal from the memory when the image capture button is pressed;
a playing module configured for playing the selected audible countdown signal through the speaker; and
a capturing module configured for capturing an image with the camera after the selected audible countdown signal is finished playing.

2. The system according to claim 1, wherein the selecting module is further configured for providing a user interface that comprises a plurality of delay times corresponding to the multiple audible countdown signals respectively, and guiding a user to select a delay time from the user interface.

3. The system according to claim 2, wherein the audible countdown signal is selected by the selecting module according to the selected delay time.

4. The system according to claim 1, further comprising a storing module configured for storing the captured image into the memory.

5. A method for image capturing with an audible countdown, the method comprising:
providing a handheld device, the handheld device comprises an image capture button, a speaker, a camera and a memory that stores multiple audible countdown signals;
pressing the image capture button;
selecting an audible countdown signal from the memory;
playing the selected audible countdown signal through the speaker; and
capturing an image through the camera after the selected audible countdown signal is finished playing.

6. The method according to claim 5, further comprising:
providing a user interface that comprises a plurality of delay times corresponding to the multiple audible countdown signals respectively, and guiding a user to select a delay time from the user interface before the selecting step.

7. The method according to claim 6, wherein the audible countdown signal is selected according to the selected delay time.

8. The method according to claim 5, further comprising: storing the captured image into the memory after the capturing step.
